(19) United States
(12) Patent Application Publication
(10) Pub. No.: US 2025/0003458 A1
(43) Pub. Date: Jan. 2, 2025

(54) BRAKE ARRANGEMENT WITH, E.G., A SHAFT TO BE BRAKED AND A HOUSING PART

(71) Applicant: SEW-EURODRIVE GMBH & CO. KG, Bruchsal (DE)

(72) Inventor: Gerolf FICHTNER-PFLAUM, Kraichtal-Unteröwisheim (DE)

(73) Assignee: SEW-EURODRIVE GMBH & CO. KG, Bruchsal (DE)

(21) Appl. No.: 18/709,244

(22) PCT Filed: Nov. 3, 2022
(86) PCT No.: PCT/EP2022/080693

§ 371 Date: May 10, 2024

(30) Foreign Application Priority Data
Nov. 11, 2021 (DE) 10 2021 005 578.0

(51) Int. Cl. F16D 59/02; F16D 121/22; H02K 7/102

(52) U.S. Cl. CPC F16D 59/02; H02K 7/1025; F16D 2121/22

(57) ABSTRACT

A brake arrangement includes, for example, a shaft to be braked and a housing part, and further includes a magnet body, an armature plate, an intermediate part, and a ring winding. The ring winding is accommodated in a recess in the magnet body, and the intermediate part is arranged between the housing part and the magnet body. The intermediate part includes radially inwardly projecting stop regions than project further in the axial direction towards the armature plate than a pole face formed on the magnet body.

### FIELD OF THE INVENTION

The present invention relates to a brake arrangement with, for example, a shaft to be braked and a housing part.

### BACKGROUND INFORMATION

In certain conventional systems, a brake arrangement has a shaft to be braked.

German Patent Document No. 10 2019 002 960 describes a brake arrangement for an electric motor.

An electromagnetic brake or clutch device with a damping device for improved noise reduction is described in German Patent Document No. k 10 2014 103 837.

An electromagnetically operated brake is described in German Patent Document No. 196 22 983.

An electromagnetic spring brake system is described in German Patent Document No. 199 02 195.

### SUMMARY

Example embodiments of the present invention provide for cost-effective production.

According to example embodiments of the present invention, a brake arrangement has a magnet body, an armature plate, an intermediate part, and a ring winding, e.g., a coil. The ring winding is accommodated in a recess in the magnet body, and, for example, the magnetic body is made of a ferromagnetic material and the armature plate is made of a ferromagnetic material. The intermediate part is arranged between the housing part and the magnet body, and, for example, is arranged for sealing. The intermediate part includes radially inwardly projecting stop regions that project further in the axial direction towards the armature plate than a pole face formed on the magnet body, e.g., a pole face projecting in the axial direction on the magnet body. For example, the stop regions cover a radial distance region in relation to the axis of rotation of the shaft, which radial distance region is arranged radially within the region of contact between the intermediate part and the housing part and which overlaps with the radial distance region covered by the armature plate. For example, the stop regions are at a distance from each other in the circumferential direction.

Thus, the intermediate part performs a sealing function on the one hand and serves as a noise-damping stop for the armature plate on the other. In addition, the armature plate is held rotationally fixed for conjoint rotation to the magnet body via the pins which are connected to the armature disk, and the intermediate part is arranged therebetween. The intermediate part thus performs a sealing function, a damping function, and a torque transmission function. Thus, the intermediate part is arranged as a multifunctional sealing part, e.g., as a multifunctional flat seal.

The brake arrangement can be actuated electromagnetically. This is because energizing the ring winding releases the brake and not energizing the ring winding causes the brake to be applied.

It is therefore important that the elastic intermediate part seals the housing part acting as the brake housing, dampens the armature plates before they impact on the magnet body and rubber-elastically encloses the pins connected to the armature plate and guides them as a membrane, thus damping the radial impact when the brake arrangement is activated.

According to example embodiments, pins, e.g., axially oriented pins, are connected to the armature plate, and a respective pin projects through an axially passing through recess in a respective stop region and projects through an axially passing through bore of the magnet body. For example, the respective pin is guided through the respective stop region touching it. Thus, the pins move with the armature plate during operation, e.g., when the brake is released and when the brake is applied. In this manner, the armature plate is constantly guided because the pins always project through the respective bores passing axially through the magnet body and are distanced from the magnet body via the intermediate part and, if applicable, via a further sealing part.

According to example embodiments, the respective stop region distances the respective pin from the wall of the bore through which the pin projects, for example, by the respective stop region projecting into the respective bore. Thus, the intermediate part distances the pin from the magnet body. Thus, the metallic pin does not impact on the metallic magnet body, but the more elastic intermediate part, e.g., as a rubber or plastic part, dampens impulses and/or jerks, e.g., shocks.

According to example embodiments, a further sealing element is accommodated in the respective bore of the magnet body and seals towards the pin. Thus, the interior space of the brake arrangement is sealed off towards the releaser or the outside environment.

According to example embodiments, projections projecting radially outwards are formed on the armature plate, which projections impact on the stop regions when the brake is released, e.g., when the ring winding is energized and/or a manual release is actuated. For example, the radial distance region covered by the projections overlaps with the radial distance region respectively covered by the stop regions. Thus, the mass of the armature plate can be kept low, since the outer circumference is radially recessed in those circumferential angular regions that are not covered by the projections.

According to example embodiments, spring elements supported on the magnet body press on the armature plate, and the armature plate is arranged in axially movable manner and arranged in rotationally fixed manner to the magnet body via the pins. Thus, when the ring winding accommodated in the magnet body is not energized, the spring elements push the armature plate away from the magnet body.

According to example embodiments, the intermediate part is arranged between the magnet body and the armature plate. Thus, the impact of the armature plate is dampened via the intermediate part.

According to example embodiments, a brake pad carrier is connected to the shaft for conjoint rotation and arranged in axially movable manner relative to the shaft, e.g., in that an internal toothing meshes with an external toothing of a ring-like tappet, which is connected to the shaft for conjoint rotation, e.g., via a key connection. The brake pad carrier is arranged axially between the armature plate and a braking face formed on a bearing flange. Thus, when the ring winding is energized, the brake is released by the armature plate being pulled towards the magnet body, thus releasing the brake pad carrier. When the ring winding is not energized, the armature plate is pressed onto the brake pad carrier by the spring elements, which, for example, act as brake springs, so that the brake pad carrier is pressed onto the braking face on the side facing away from the armature plate, thereby applying the brake, i.e., introducing braking torque into the shaft.

According to example embodiments, the armature plate is pressed towards the brake pad carrier by the spring elements when the ring winding is not energized, so that the brake pad carrier is pressed onto the braking face, and when the ring winding is energized, the armature plate is moved towards the magnet body against the spring force generated by the spring elements. Thus, the brake is applied automatically in the event of a power failure.

According to example embodiments, the pole face is shaped like a circular ring and is formed flat, e.g., as a plane, on its end face facing the armature plate. Thus, the magnetic field preferentially emerges from the pole face since this projects from the magnetic body. Thus, an optimized effect of the magnetic field lines on the armature plate is achieved and/or tilting of the armature plate can be prevented.

According to example embodiments, the intermediate part is formed to completely extend around in the circumferential direction, e.g., uninterruptedly. Thus, the sealing function can be carried out around the entire circumference.

According to example embodiments, the intermediate part surrounds the pole face radially, e.g., completely. Thus, the interior space of the brake is sealed via the housing part and the intermediate part arranged between the housing part and the magnet body. The housing part is connected to a bearing flange on its side facing away from the intermediate part, and a flat seal is also arranged therebetween. In this manner, the interior space of the brake is delimited and enclosed by the bearing flange with the flat seal, the housing part, the intermediate part, and the magnet body.

According to example embodiments, the end region of the pins facing away from the armature plate axially delimits a lever part which is subjected to spring force applied by a further spring part supported on a screw. For example, the lever part is supported on the magnet body, and a manual release lever is connected to the lever part. Thus, the pins allow the brake to be released manually.

According to example embodiments, the intermediate part, e.g., together with the stop regions, is formed in one piece and/or in one part, e.g., as an injection-molded part, as a plastic injection-molded part, etc. Thus, a multifunctional intermediate part can be produced readily and cost-effectively.

According to example embodiments, the armature plate and the magnet body are made of a respective ferromagnetic material. Thus, both parts are metallic.

According to example embodiments, the ring axis of the ring winding is oriented coaxially to the axis of rotation of the shaft. Thus, the magnetic field is symmetrically distributed and thus the armature plate is not tilted and/or is located optimally in the magnetic flux.

According to example embodiments, in an electric motor with a brake arrangement, the housing part is tightly connected to a bearing flange of the electric motor, and the shaft, e.g., the rotor shaft, is rotatably mounted via a bearing accommodated in the bearing flange. A braking face is formed on the bearing flange, and the bearing flange is connected on its side facing away from the housing part to a stator housing part of the electric motor, which stator housing part radially surrounds a stator winding of the electric motor. For example, the stator housing part is connected on its side facing away from the bearing flange to a second bearing flange in which a second bearing for rotatably mounting the rotor shaft is accommodated.

Thus, the brake arrangement can be provided integrated on the motor and the bearing flange can be used not only for accommodation of a bearing, but also for dissipating the frictional heat of the brake.

Further features and aspects of example embodiments of the present invention are explained in more detail below with reference to the appended schematic Figures.

### BRIEF DESCRIPTION OF THE DRAWINGS

FIG. 1 is a perspective view of a brake arrangement, e.g., a brake arrangement of an electric motor.

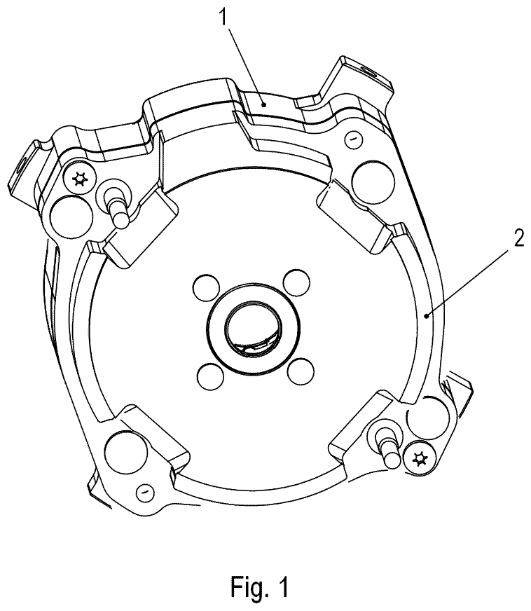

FIG. 2 is an exploded perspective view of the partial region without a housing part 1.

FIG. 3 is a perspective view of an intermediate part 24 of the brake arrangement arranged as a multifunctional flat seal.

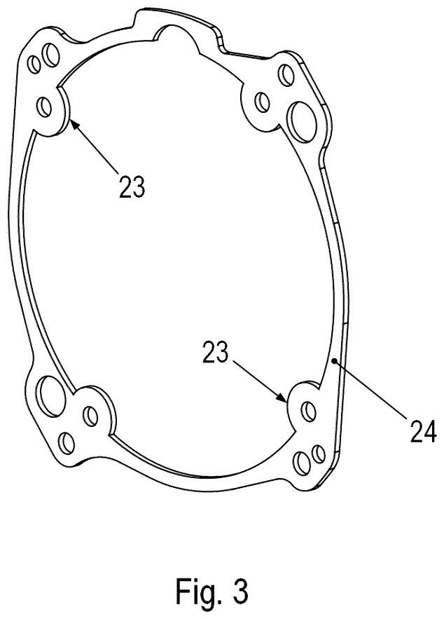

FIG. 4 is a perspective view of a magnet body 2 of the brake arrangement.

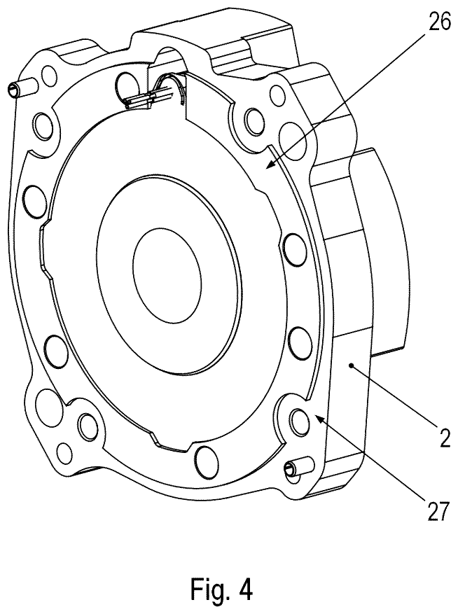

FIG. 5 is a perspective view of the partial region of the brake arrangement.

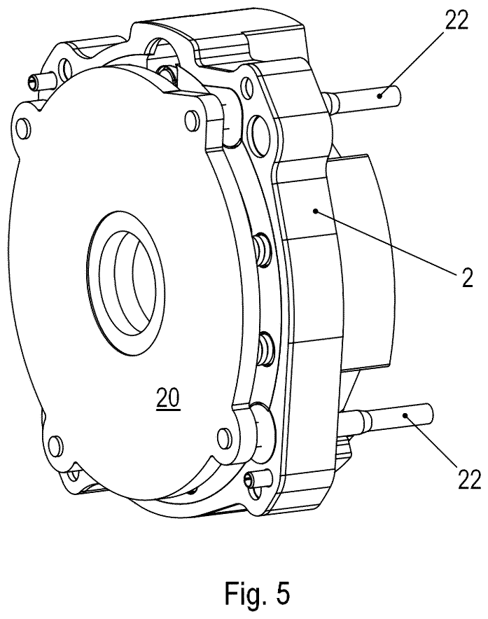

FIG. 6 is a cross-sectional view of the brake arrangement of the electric motor.

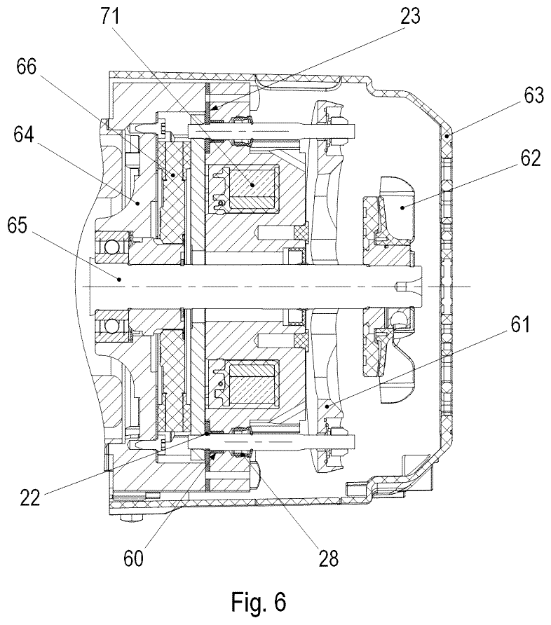

FIG. 7 is a further cross-sectional view of the brake arrangement of the electric motor, in which the cross-sectional plane is arranged rotated relative to the sectional plane of FIG. 6.

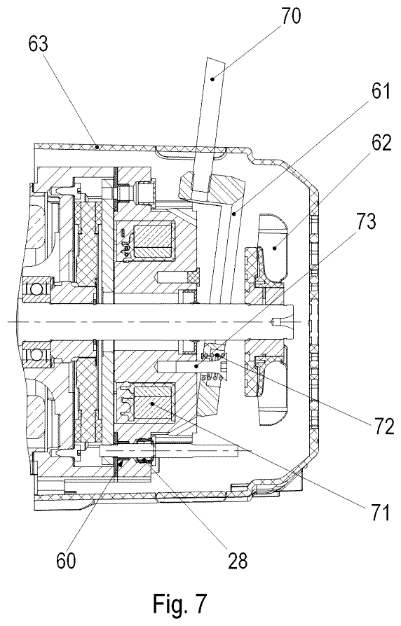

FIG. 8 is a perspective view of the brake arrangement.

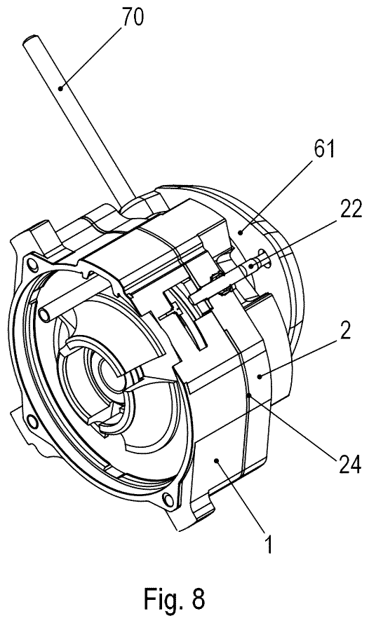

### DETAILED DESCRIPTION

As illustrated in the Figures, the brake arrangement has a magnetic body 2 which is made of a ferromagnetic material, e.g., cast steel, especially gray cast iron.

In the magnet body 2, a ring winding 71 is accommodated as a coil in a ring-like recess, and the ring axis, e.g., the winding axis, of the ring winding 71 is oriented coaxially to the axis of rotation of a shaft, e.g., rotor shaft of an electric motor, to be braked by the brake arrangement.

The axial direction, the radial direction, and the circumferential direction always relate to the axis of rotation of the shaft.

An armature plate 20 is connected to axially directed pins 22, which project through axial bores of the magnetic body 2. The armature plate 20 is thus arranged rotationally fixed towards the magnet body 2 in the circumferential direction. However, the armature plate 20 can be moved in an axial direction, e.g., against the spring force generated by the spring elements 25 supported on the magnet body 2. The pins 22 move with the armature plate 20.

The armature plate 20 is made of ferromagnetic material, e.g., steel. When the ring winding 71 is energized, the armature plate is pulled towards the magnet body against the spring force generated by the spring elements 25 until the armature plate 20 rests against the pole faces projecting in the axial direction on the magnet body 2.

The circumferential direction, axial direction, and radial direction always relate to the direction of the axis of rotation of the shaft, e.g., rotor shaft, to be braked by the brake arrangement.

The housing part 1 is pressed against the magnet body 2 by screws, and an intermediate part 24 is arranged therebetween. Thus, the housing part 1 does not touch the magnet body 2 directly at a contact surface 27, but the intermediate part 24 rests against the contact surface 27 on the one hand and against the housing part 1 on the other.

The contact surface 27 is, for example, formed uninterrupted in the circumferential direction. The region covered by the housing part 1 in the axial direction includes the region covered by the armature plate 20 in the axial direction. The armature plate 20 is at a distance from the housing part 1 in the radial direction. Thus, the housing part 1 of the brake arrangement encloses the working region of the armature plate 1 and provides for the magnet body 2 to be fastened to the electric motor, e.g., to a first bearing flange 64 of the electric motor.

The first bearing flange 64 accommodates a first bearing of the rotor shaft and is connected to the stator housing of the electric motor. A second bearing flange accommodates a second bearing of the rotor shaft and is also connected to the stator housing, but is distanced from the first bearing flange 64 via the stator housing.

A braking face, i.e., a finely machined face, is formed on the first bearing flange 64, against which braking face a disk-like brake pad carrier 66 can be pressed.

A ring-like tappet is fitted onto the shaft, which tappet is connected to the shaft in a form-fitting manner and has an external toothing which meshes with an internal toothing of the brake pad carrier fitted onto the tappet. Thus, the brake pad carrier 66 is movable relative to the tappet in the axial direction, but connected in a form-fitting manner in the circumferential direction, i.e., for example, connected for conjoint rotation.

The brake pad carrier 66 is arranged in the axial direction between the armature plate 20 and the braking face. Thus, when the ring winding 71 is energized, the brake pad carrier 66 is released because the armature plate 20 moves from the brake pad carrier 66 towards the magnet body 2 and thus the brake arrangement is in the released state. When the ring winding 71 is de-energized, on the other hand, the spring elements 25 supported on the magnet body 2 press the armature plate 20 onto the brake pad carrier 66, which is then pressed onto the braking face. This represents the applied state of the brake arrangement.

Since the pole face 26 on the magnet body 2 projects axially, the armature plate 20 can touch this pole face 26 when the brake arrangement is released.

The intermediate part 24 is arranged between the housing part 1 and the magnet body 2, so that contact with the housing part 1 does not occur directly, but the intermediate part 24 rests against the contact surface 26 of the magnet body 2 and the housing part 1 is pressed onto the intermediate part 24.

The intermediate part 24 is made of an elastic material, such as plastic or rubber, and thus performs a sealing function.

The contact surface 17 is axially recessed relative to the pole face 26 and is designed as a flat surface, and the flat surface projects radially inwards in those circumferential angular regions which are covered by the projections 21 of the armature plate 20 and the housing part 1 does not extend into the corresponding radial distance regions.

However, the intermediate part 24 also rests against the contact surface 17 in these regions and serves there as a stop region 23 for the armature plate 20. This is because when the housing part 1 is pressed against the intermediate part 24, this intermediate part 24 is elastically deformed such that it no longer projects beyond the pole face 26 in the axial direction. However, this does not apply to those regions, i.e., stop regions 23, in which the housing part 1 does not touch the intermediate part 24. This is because there the intermediate part 24 projects further in the axial direction than the pole face 26, so that the armature plate 20 with its radially directed projections 21 strikes first in these regions, i.e., stop regions 23, of the intermediate part 24, which project axially beyond the pole faces 26 because they are not covered and deformed by the housing part 1.

The wall thickness of the intermediate part 24 measured in the axial direction is greater outside the stop areas 23 in the non-deformed state of the intermediate part 24 than the axial distance between the contact surface 17 and the pole face 26.

In each of the stop regions 23, the intermediate part has an axially passing through recess through which one of the pins 22 projects. For example, the pin 22 is in uninterrupted contact with the intermediate part 24 in the circumferential direction, e.g., thus enclosed in a form-fitting pressed manner, and thus held in its intended target position in the radial direction and in the circumferential direction, while the respective pin 22 is very well permitted to move in the axial direction. For example, the intermediate part acts like a membrane attached to the pin.

The respective pin 22 projects through the bore of the magnet body 2, and a sealing element 28 is arranged in the bore, which seals the pin 22 towards the magnet body 2. However, the sealing element 28 can be dispensed with or, if present, provides a redundant seal if the stop regions 23 are thickened in the axial direction and project into the respective bores. These thickened regions 60 of the intermediate part 24 allow a longer axial region in which the respective pin 22 rests against the intermediate part 24 and is guided. The pin 22 projects through the recess in the intermediate part 24 and is arranged substantially play-free, i.e., directly against the, e.g., entire wall of the recess.

For example, the thickened region 60 is shaped such that the pin 22 rests against at least two partial regions of the region 60, and the partial regions are distanced from each other by a further partial region in which the pin 22 does not rest against the intermediate part 24.

The intermediate part 24 is formed in one piece, i.e., in one part, e.g., as an injection-molded part, as an elastomer injection-molded part, as a plastic injection-molded part, etc.

The intermediate part 24 thus acts as a multifunctional sealing element, since it ensures the sealing function between the housing part 1 and the magnet body 2, serves as a stop face for the armature plate 20 and transmits the braking torque from the armature plate 20 via the pins 22 to the magnet body 2, e.g., in a damping manner.

A first portion of the braking torque is transmitted from the brake pad carrier 66 to the armature plate 20 and a second portion of the braking torque from the brake pad carrier 66 to the braking face. However, since the armature plate 20 is prevented by the pins 22 from co-rotating during braking, in that the pins 22 are being held in a form-fitting manner in the respective recess in the magnet body 2 via the intermediate part 24, e.g., via the thickened regions 60 of the intermediate part 24.

To perform the sealing function, the intermediate part on its side facing the magnet body 2 touches the latter uninterruptedly, e.g., extending around in the circumferential direction, and on its side facing away from the magnet body 2 touches the housing part 1 uninterruptedly, e.g., extending around in the circumferential direction.

The armature plate 20 arranged radially inside the housing part 1 strikes the intermediate part 24 because the latter projects radially inwards and is not deformed there by the housing part 1, so that it projects beyond the pole face 26 towards the armature plate 2, e.g., projects axially towards the armature plate more than the pole face 26, and is thus touched first when the brake is released. Only after further deformation can the armature plate 20 touch the pole face 26.

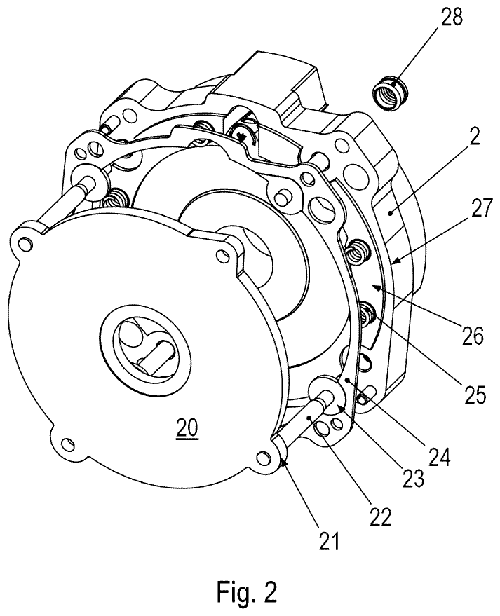

As illustrated in FIG. 2, for contact with the intermediate part 24, the armature plate has the projections 21 projecting radially from the armature plate 20. These projections 21 are arranged at a greater radial distance than the pole face 26. The projections 21 are thus at a radial distance from the pole face 26.

The pole face 26 is formed like a perforated disk, and axial bores distanced from each other in the circumferential direction penetrate the pole face 26, which are provided for accommodating the spring elements 25 acting, for example, as brake springs.

The magnetic field generated by the ring winding 71, for example, passes through the pole face 26, e.g., substantially in the axial direction.

The pins 22 act as draw bars for manual release. The end region of the respective pin 22 facing away from the armature plate 20 projects through a respective recess in the lever part 61 and is secured by a nut screwed onto a threaded region of the end region.

The screw head of a screw 73, which projects axially through a further recess in the lever part 61 and is screwed into an axial threaded hole in the magnet body 2, delimits the lever part 61 in the axial direction, and a spring part 72 supported on the screw head generates a restoring force for the lever part 61. Thus, manual release of the brake is only possible by actuating a lever 70, which is firmly connected to the lever part 61, e.g., while overcoming the spring force generated by the spring part 72.

At the axial end region of the shaft 65, a releaser wheel 62 is firmly connected for conjoint rotation with the shaft 65. A releaser hood 63 radially surrounds the brake arrangement together with the releaser wheel 62.

The region covered by the pole face 26 in the axial direction is included by the region covered by the intermediate part 24 in the axial direction.

A radial distance region covered by a stop region 23 should be understood to be that region of radial distances which is covered by the respective stop region 23. This radial distance region overlaps with the radial distance region covered by the armature plate.

For example, the intermediate part 24 is arranged as a flat seal, e.g., without the thickenings 60.

### LIST OF REFERENCE NUMERALS

1 Housing part
2 Magnetic body
20 Armature plate
21 Projection, e.g., a projection projecting radially from the armature plate
22 Pin
23 Stop region
24 Intermediate part, e.g., multifunctional intermediate part
25 Spring element
26 Pole face, e.g., a pole face projecting axially from the magnet body 2
27 Contact surface of the magnetic body 2 for the housing part 1
28 Sealing element
60 Thickened region of the intermediate part 24, e.g., projecting axially
61 Lever part
62 Releaser wheel
63 Releaser hood
64 Bearing flange
65 Rotor shaft
70 Manual release lever
71 Ring winding
72 Spring part
73 Screw

1-15. (canceled)

16. A brake arrangement, comprising:
a shaft to be braked;
a housing part;
a magnet body including a recess;
an armature plate;
an intermediate part arranged between the housing part and the magnet body and including radially inwardly projecting stop regions that project further in an axial direction toward the armature plate than a pole face formed on the magnet body; and
a ring winding accommodated in the recess in the magnet body.

17. The brake arrangement according to claim 16, wherein the magnetic body is made of a ferromagnetic material, and the armature plate is made of a ferromagnetic material.

18. The brake arrangement according to claim 16, wherein the stop regions cover a radial distance region in relation to an axis of rotation of the shaft, the radial distance region being arranged radially within a region of contact between the intermediate part and the housing part and overlapping with a radial distance region covered by the armature plate.

19. The brake arrangement according to claim 16, wherein the stop regions are arranged at a distance from each other in a circumferential direction.

20. The brake arrangement according to claim 16, wherein pins are connected to the armature plate, a respective pin projecting through an axially passing through recess in a respective stop region and project through an axially passing through bore of the magnet body.

21. The brake arrangement according to claim 20, wherein the respective pin is enclosed in a form-fitting pressed manner by the intermediate part and and/or the respective pin is guided through and touches the respective stop region.

22. The brake arrangement according to claim 20, wherein the respective stop region distances the respective pin from a wall of a bore through which the pin projects.

23. The brake arrangement according to claim 22, wherein the respective stop region projects into the respective bore.

24. The brake arrangement according to claim 20, wherein a sealing element is accommodated in a respective bore of the magnet body and seals towards the pin.

25. The brake arrangement according to claim 16, wherein projections project radially outwardly from the armature plate, the projections adapted to impact on the stop regions when the brake is released.

26. The brake arrangement according to claim 25, wherein the brake is adapted to be released in response to energizing the ring winding and/or actuating a manual release.

27. The brake arrangement according to claim 25, wherein a radial distance region covered by the projections overlaps with a radial distance region respectively covered by the stop regions.

28. The brake arrangement according to claim 20, wherein spring elements supported on the magnet body press on the armature plate, the armature plate being arranged in an axially movable manner and arranged in a rotationally fixed manner to the magnet body by the pins.

29. The brake arrangement according to claim 16, wherein the intermediate part is arranged between the magnet body and the armature plate.

30. The brake arrangement according to claim 16, wherein a brake pad carrier is connected to the shaft for conjoint rotation and arranged in an axially movable manner relative to the shaft.

31. The brake arrangement according to claim 30, wherein an internal toothing meshes with an external toothing of a tappet connected to the shaft for conjoint rotation, the brake pad carrier being arranged axially between the armature plate and a braking face formed on a bearing flange.

32. The brake arrangement according to claim 31, wherein the armature plate is adapted to press toward the brake pad carrier when the ring winding is not energized so that the brake pad carrier is pressed onto the braking face, and the armature plate is adapted to move toward the magnet body against spring forces generated by spring elements when the ring winding is energized.

33. The brake arrangement according to claim 16, wherein the pole face is shaped like a circular ring and is formed flat on an end face facing the armature plate.

34. The brake arrangement according to claim 16, wherein the intermediate part is arranged to completely extend around in a circumferential direction and/or surrounds the pole face radially.

35. The brake arrangement according to claim 20, wherein end regions of the pins facing away from the armature plate axially delimit a lever part that is subjected to spring force applied by a spring part supported on a screw.

36. The brake arrangement according to claim 35, wherein the lever part is supported on the magnet body, and a manual release lever is connected to the lever part.

37. The brake arrangement according to claim 16, wherein the intermediate part is formed in one piece, in one part, as an injection-molded part, as an elastomer injection-molded part, and/or as a plastic injection-molded part.

38. The brake arrangement according to claim 16, wherein the armature plate and the magnet body are made of a respective ferromagnetic material.

39. The brake arrangement according to claim 16, wherein a ring axis of the ring winding is oriented coaxially to an axis of rotation of the shaft.

40. An electric motor, comprising:
a brake arrangement as recited in claim 16;
wherein the housing part is tightly connected to a bearing flange of the electric motor,
wherein the shaft is rotatably mounted by a bearing accommodated in the bearing flange;
wherein a braking face is arranged on the bearing flange;
wherein the bearing flange is connected on a side facing away from the housing part to a stator housing part of the electric motor, the stator housing part radially surrounding a stator winding of the electric motor.

41. The electric motor according to claim 40, wherein the stator housing part is connected on a side facing away from the bearing flange to a second bearing flange that accommodates a second bearing that rotatably mounts the rotor shaft.
